(19) United States
(12) Patent Application Publication
(10) Pub. No.: US 2002/0071712 A1
(43) Pub. Date: Jun. 13, 2002

(54) Walking/running race memorabilia and method of storing the same

(76) Inventor: Delbert Backs, Bloomington, IN (US)

Correspondence Address: Michael B. McNeil, Liell & McNeil Attorneys P.C., P. O. Box 2417, Bloomington, IN, 47402, US

(21) Appl. No.: 09/732,283

(22) Filed: Dec. 7, 2000

(51) Int. Cl. B42F 3/02

(52) U.S. Cl. 402/79

(57) ABSTRACT

A walking/running race event item comprises a document having loose leaf mounting features. The document includes a race event participant data section and a race logo, wherein the race logo includes an image unique to a particular walking/running race.

### TECHNICAL FIELD

This invention relates generally to walking and/or running race event items, and more particularly to walking/running race event items including a race logo and race participant data and a method of storing the same.

### BACKAROUND ART

Participants in a walking/running race, such as a marathon, are often given a race event item to commemorate their participation in the race. Typically, this item is a T-shirt that includes a unique race logo and possibly the date and location of the race. While this is a nice reminder of the event, shirts can wear out, if used, and are not easy to store in a manner that allows the participant to review their accomplishments. In addition, there is typically no designated section of the shirt that is reserved for race participant data, such as the participant's name and their race finishing time. Thus, a race item that is easily stored in a ready to view manner and that included both the race information and a section for entry of race participation data would be desirable.

In addition to receiving a T-shirt or other race commemoration item, participants typically also keep the race bib that they wore during the race, and which includes their participant number. However, as with the T-shirt or other race commemoration item, there is typically no designated section on the race bib for the participant to enter such data as their name or personal race finishing time. Further, it is often difficult to store the race bib and T-shirt for each race in a manner that allows the participant to reflect upon their accomplishments over the span of their career.

The present invention is directed to overcoming one or more of the problems as set forth above.

### DISCLOSURE OF THE INVENTION

In one aspect of the present invention, a walking/running race event item comprises a document having loose leaf mounting features. The document includes a walking/running race event participant data section and a race logo, wherein the race logo includes an image unique to a particular race.

In another aspect of the present invention, a personal walking/running race event history album comprises a binder that includes a plurality of transparent sleeves. Each of said sleeves includes loose leaf mounting features and a document commemorating a walking/running race event. Each of the documents including a race logo section and a race event participant data section. Each of the sleeves are sized and shaped to hold a race bib.

In yet another aspect of the present invention, a method of organizing personal walking/running race memorabilia comprises a step of entering a walking/running race event participant data entry on a document that includes features unique to a walking/running race event. The document is then mounted in a binder.

### BRIEF DESCRIPTION OF THE DRAWINGS

FIG. 1 is a top view of an album including a plurality of storage sleeves according to the present invention;

FIG. 2 is a front view of the storage sleeve of FIG. 1; and

FIG. 3 is a back view of the storage sleeve of FIG. 1.

### BEST MODE FOR CARRYING OUT THE INVENTION

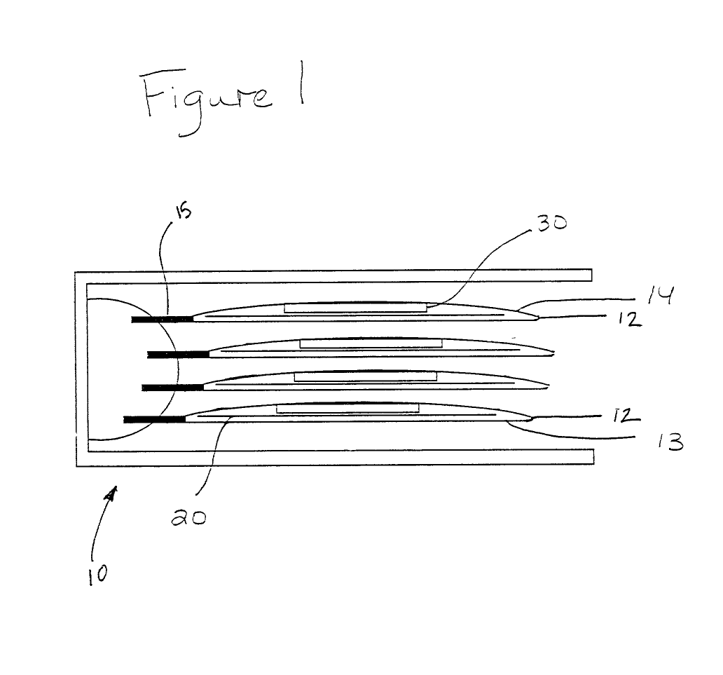

Referring to FIG. 1 there is shown an album 10 according to the present invention. A plurality of storage sleeves 12 are removably mounted in album 10. Each storage sleeve 12 includes a front side 13 and a back side 14. Storage sleeve 12 is preferably transparent, however, it should be appreciated that it could instead be translucent. Storage sleeve 12 preferably includes loose leaf mounting features 15 to allow it to be removably stored in album 10. As illustrated, loose leaf mounting features 15 include a plurality of holes 16 that allow storage sleeve 12 to be stored in a three-ring binder style album 10. However, it should be appreciated that other mounting features 16 could be utilized, depending on the style of album 10. For instance, mounting features 15 could include an overhang portion, similar to that which defines mounting holes 16, adjacent the top of storage sleeve 12, to allow storage sleeve 12 to be mounted in a clamp style binder.

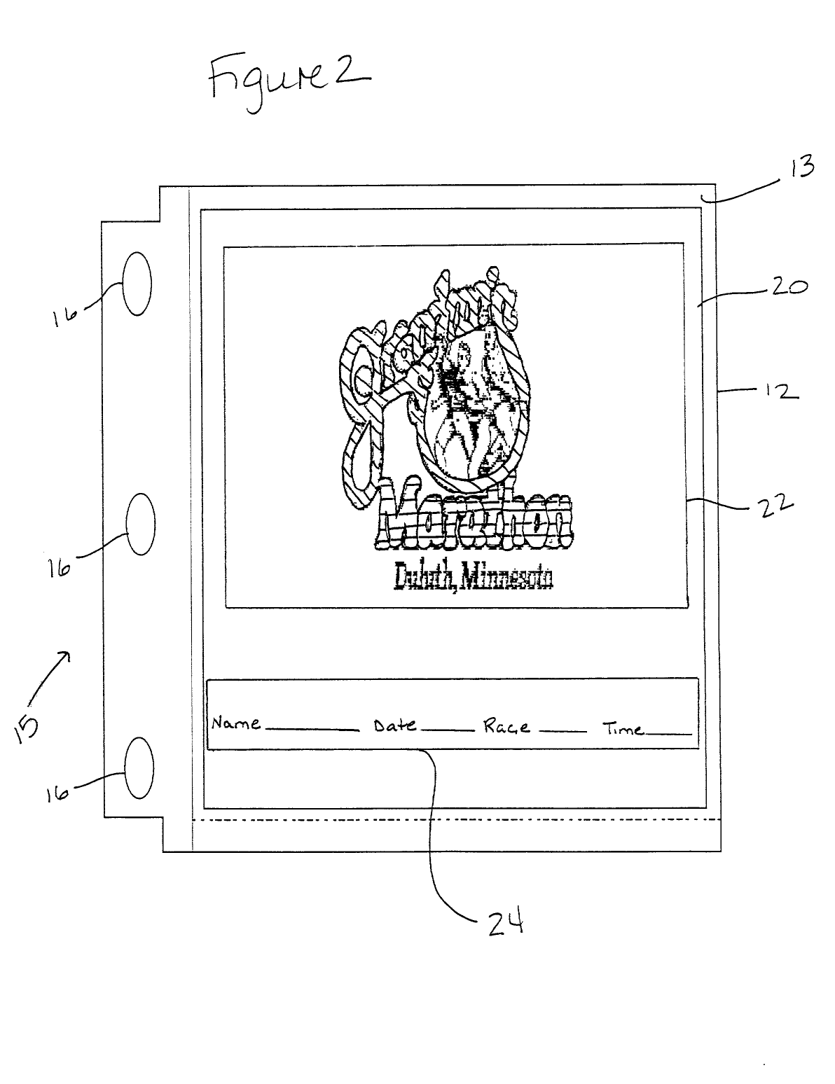

Referring in addition to FIG. 2, an event document 20 is contained within sleeve 12. Document 20 preferably commemorates a walking/running race event. Document 20 could be composed of any suitable paper, such as cardstock or even typing paper. In addition, document 20 is preferably sized such that it can be conveniently mounted in an appropriate album. For instance, document 20 could be approximately 8 ½ inches by 11 inches, or approximately the size of standard typing paper.

Included on document 20 is a race logo 22 that is preferably a multi-color image or design that includes a unique race identifier. In addition, race logo 22 could also include such information as the date of the race and race location. Also included on document 20 is a race participant data section 24 that preferably includes a participant name entry, a race date entry, a race entry and a race completion time entry. However, it should be appreciated that race participant data section 24 could include additional entries, such as race participant identifying number or race location, if the race is carried out in multiple locations. Likewise, participant data section 24 could include fewer entries. For instance, if race logo 22 includes the date of the race, this entry could be excluded from race participant data section 24.

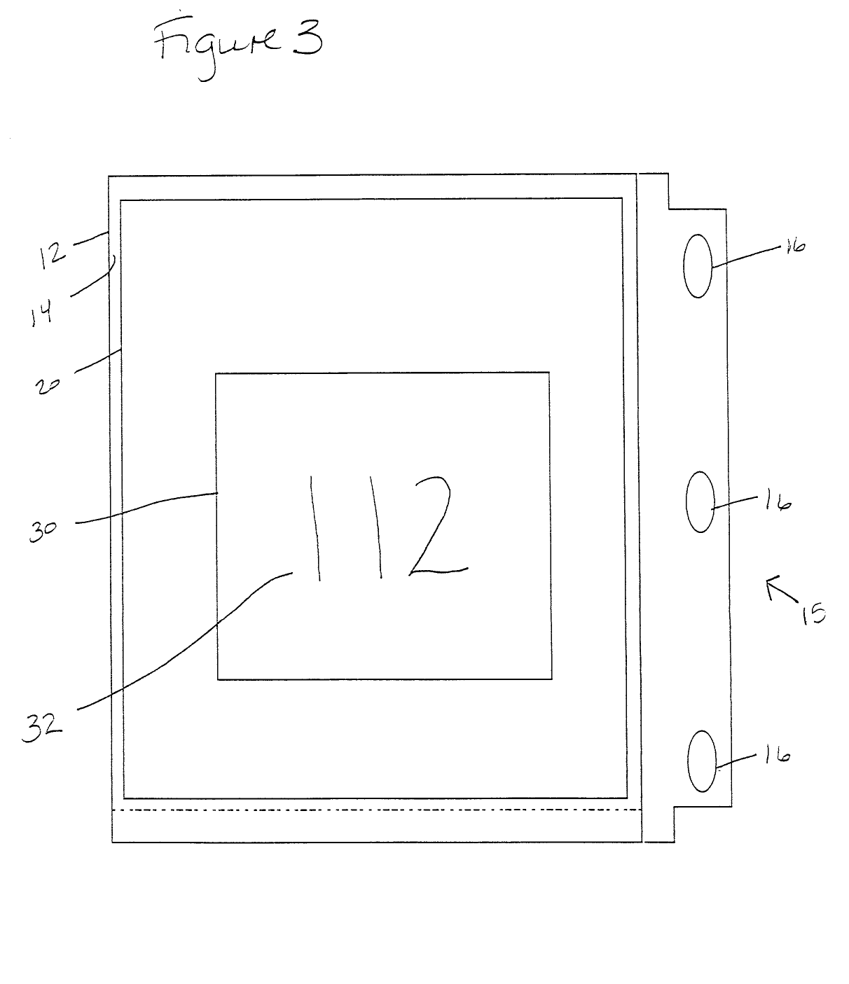

In addition to serving as a means for storing race document 20. Sleeve 12 is also preferably sized and shaped to hold a race bib 30. Referring in addition to FIG. 3, race bib 30 preferably includes an alphanumeric race participant identifier 32. As illustrated, document 20 and race bib 30 can be inserted into sleeve 12 such that race logo 22 and race participant data section 24 are visible through front side 13, while race participant identifier 32 of race bib 30 is visible through back side 14.

It should be understood that the above description is intended for illustrative purposes only, and is not intended to limit the scope of the present invention in any way. Therefore, it should be appreciated that various modifications could be made to race document 20 without departing from the scope of the present invention. For instance, document 20 itself could include loose leaf mounting features, such as holes for insertion into a three-ring binder style album 10. In this modification, document 20 could be stored in album 10 without the use of sleeve 12. It should be appreciated that race bib 30 could be joined with race document 20 in some alternative manner, such as with staples or either a temporary or permanent adhesive.

In addition, race document 20 could be modified to include race logo 22 on the front side of race document 20 and race participant data section 24 on the back side of race document 20. It should be appreciated that in this instance, race participant data section 24 could be positioned on the back side of race document 20 such that it is visible when race document 20 is joined with race bib 30.

Thus, those skilled in the art will appreciate that other aspects, objects and advantages of this invention can be obtained from a study of the drawings, the disclosure and the appended claims.

1. A walking/running race event item comprising:
a document having loose leaf mounting features; and
said document including a walking/running race event participant data section and a race logo, wherein said race logo includes an image unique to a particular race.

2. The race event item of claim 1 wherein said loose leaf mounting features include a plurality of holes for mounting said document in a binder.

3. The race event item of claim 1 wherein said race logo is a multi-color design.

4. The race event item of claim 1 wherein said race participant data section includes a participant name entry, a date entry, a race entry and a completion time entry.

5. A personal walking/running race event history album comprising:
a binder including a plurality of transparent sleeves;
each of said sleeves including loose leaf mounting features and a document commemorating a walking/running race event;
each of said documents including a race logo section and a race event participant data section; and
each of said sleeves being sized and shaped to hold a race bib.

6. The album of claim 5 wherein said race participant data section includes a participant name entry, a date entry, a race entry and a completion time entry.

7. The album of claim 6 wherein each of said sleeves includes a front side and a back side;
said document is stored in said sleeve such that said race logo section and said race participant data section are visible through said front side; and
said race bib is stored in said sleeve such that a race participant identifier included on said race bib is visible through said back side.

8. The album of claim 5 wherein said race logo includes a multi-color design unique to a particular race.

9. A method of organizing personal walking/running race memorabilia comprising:
entering a walking/running race event participant data entry on a document that includes features unique to a walking/running race event; and
mounting said document in a binder.

10. The method of claim 9 wherein said step of entering a race event participant data entry includes a step of entering a race participant name, a race date, a race identifier and a completion time on said document.

11. The method of claim 10 including the step of joining a race bib to said document.

12. The method of claim 11 including the step of storing said document and said race bib in a transparent sleeve such that said race logo and said race event participant data entry are visible through a front side of said sleeve and said race bib is visible through a back side of said sleeve.
